(19) United States
(12) Patent Application Publication
(10) Pub. No.: US 2025/0388004 A1
(43) Pub. Date: Dec. 25, 2025

(54) Antenna Integrated Structural Polymer Glazing With Autoshading

(71) Applicant: GM GLOBAL TECHNOLOGY OPERATIONS LLC, Detroit, MI (US)

(72) Inventors: Bradley Allen NEWCOMB, Troy, MI (US); Jonglee PARK, Novi, MI (US); Jang Hwan OH, Troy, MI (US)

(21) Appl. No.: 18/750,774

(22) Filed: Jun. 21, 2024

(51) Int. Cl. B32B 17/10; H01Q 1/12; H01Q 13/10

(52) U.S. Cl. CPC B32B 17/10495; B32B 17/10036; B32B 17/10366; B32B 17/10779; B32B 17/10788; H01Q 13/10; B32B 2305/08; B32B 2305/34; B32B 2307/202; B32B 2307/412; B32B 2311/16; B32B 2315/08; B32B 2329/06; B32B 2331/04; B32B 2367/00; B32B 2605/00; H01Q 1/1271

(57) ABSTRACT

A glazing system includes a first transparent layer comprising at least one of glass and a polymer. A first conductive layer arranged on one side of an autoshading layer. A second conductive layer arranged on an opposite side of the autoshading layer and including an antenna. A second transparent layer includes at least one of glass and a polymer. The autoshading layer, the first conductive layer and the second conductive layer are arranged between the first transparent layer and the second transparent layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to antennas for vehicles, and more particularly to an antenna that is integrated into structural polymer glazing with autoshading capability.

Transparent antennas have been integrated into glazing such as windshields, side window glass, transparent roofs, rear windows, or other components of vehicles. Autoshading can be used to adjust the amount of light passing through the glazing. Autoshading typically requires conductive layers sandwiching an autoshading layer. Transparent antennas have not been successfully incorporated with autoshading technologies due to electromagnetic interference.

### SUMMARY

A glazing system includes a first transparent layer comprising at least one of glass and a polymer. A first conductive layer arranged on one side of an autoshading layer. A second conductive layer arranged on an opposite side of the autoshading layer and including an antenna. A second transparent layer includes at least one of glass and a polymer. The autoshading layer, the first conductive layer and the second conductive layer are arranged between the first transparent layer and the second transparent layer.

In other features, a first layer includes polyethylene terephthalate (PET) and a second layer includes at least one of polyvinyl butyral (PVB) and ethylene vinyl acetate (EVA) arranged between the first transparent layer and the first conductive layer. A third layer includes polyethylene terephthalate (PET) and a fourth layer includes at least one of polyvinyl butyral (PVB) and ethylene vinyl acetate (EVA) arranged between the second transparent layer and the second conductive layer.

In other features, the first conductive layer and the second conductive layer are transparent. The first conductive layer and the second conductive layer include indium tin oxide (ITO). First and second structural composites arranged on opposite lateral sides of the autoshading layer, the first conductive layer, and the second conductive layer.

In other features, the first and second structural composites comprise a polymer and reinforcing fibers encapsulated in the polymer, and the reinforcing fibers are non-conducting.

In other features, the antenna comprises a slot antenna. The antenna is arranged below at least one of the first and second structural composites. A first polyethylene terephthalate (PET) layer is arranged between the first transparent layer and the first conducting layer and a second PET layer is arranged between the second transparent layer and the second conducting layer.

A vehicle includes the glazing, a transceiver configured to transmit signals to and receive signals from the antenna, and an autoshading controller configured to adjust shading of the autoshading layer. The glazing system comprises one of a roof, a windshield, and a rear window of the vehicle.

A glazing system includes a first layer comprising polyethylene terephthalate (PET), a first conductive layer arranged on one side of the first layer. An autoshading layer is arranged adjacent to the first conductive layer. A second conductive layer is arranged adjacent to the autoshading layer and includes an antenna. A second layer includes PET arranged adjacent to the second conducting layer. A first structural composite is arranged laterally adjacent to one side of the first layer, the first conductive layer, the autoshading layer, the second conductive layer, and the second layer. A polymer layer encapsulates the structural composite, the first layer, the first conductive layer, the autoshading layer, the second conductive layer, and the second layer.

In other features, at least one of the first conductive layer and the second conductive layer is transparent. The first conductive layer and the second conductive layer include indium tin oxide (ITO). A second structural composite is arranged laterally adjacent to an opposite side of the first layer, the first conductive layer, the autoshading layer, the second conductive layer, and the second layer. The second structural composite is encapsulated in the polymer layer.

In other features, the first structural composite comprises a polymer and reinforcing fibers encapsulated in the polymer. The reinforcing fibers are non-conducting. The antenna comprises a slot antenna.

A vehicle includes the glazing, a transceiver configured to transmit signals to and receive signals from the antenna, and an autoshading controller configured to adjust shading of the autoshading layer. The glazing system comprises one of a roof, a windshield, and a rear window of the vehicle.

A glazing system includes a first transparent layer including glass. A first layer includes polyethylene terephthalate (PET) arranged adjacent to the first transparent layer. A second layer includes at least one of polyvinyl butyral (PVB) and ethylene vinyl acetate (EVA) arranged adjacent to the first layer. A first transparent conductive layer comprises indium tin oxide (ITO) arranged adjacent to the second layer. An autoshading layer is arranged adjacent to the first transparent conductive layer. A second transparent conductive layer includes ITO arranged on an opposite side of the autoshading layer and including an antenna. A third layer includes polyethylene terephthalate (PET) arranged adjacent to the second transparent conductive layer. A fourth layer includes at least one of polyvinyl butyral (PVB) and ethylene vinyl acetate (EVA) arranged adjacent to the third layer. A second transparent layer includes glass arranged adjacent to the fourth layer.

A vehicle includes the glazing, a transceiver configured to transmit signals to and receive signals from the antenna, and an autoshading controller configured to adjust shading of the autoshading layer, wherein the glazing system comprises one of a roof, a windshield, and a rear window of the vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B are side cross sections of examples of glazing including both autoshading and an antenna according to the present disclosure;

FIGS. 2A and 2B are side cross sections of other examples of glazing including autoshading and an antenna according to the present disclosure;

FIG. 3 is a side cross section of another example of glazing including autoshading and an antenna according to the present disclosure;

FIG. 4 is a perspective view of FIG. 3;

FIGS. 5A and 5B are side cross sections of other examples of a laminate including an autoshading layer arranged between conducting layers according to the present disclosure;

FIG. 6 is a side cross section of another example of glazing including autoshading and an antenna according to the present disclosure;

FIG. 7 is a plan cross section view of another example of glazing including autoshading and an antenna according to the present disclosure;

FIG. 8 is a side cross section of another example of glazing including autoshading and an antenna according to the present disclosure;

FIG. 9 illustrates an antenna arranged in a conductive layer according to the present disclosure; and

FIG. 10 illustrates an antenna arranged in a conductive layer and adjacent to a structural composite according to the present disclosure.

In the drawings, reference numbers may be reused to identify similar and/or identical elements.

### DETAILED DESCRIPTION

While glazing including both autoshading and one or more antenna(s) is being described in the context of vehicles, the glazing can be used in other mobile or stationary applications.

Conventional automatically shading (autoshading) glazing systems include an autoshading layer arranged between two conductive layers that are typically transparent. When a first voltage is applied across the conductive layers, the autoshading layer is transparent. When other voltages are applied across the conductive layers, the autoshading layer has variable shading levels that depend upon the applied voltage.

It has been difficult to integrate both autoshading and antennas in the same glazing. Generally, the conductive layers for autoshading interfere with the operation of the antenna. In other words, the voltage levels of the conductive layers used in autoshading systems interfere with electromagnetic signals generated by the antenna. The present disclosure includes glazing that integrates one or more antennas into one of the conductive layers of the autoshading system. For example, the antenna(s) are integrated into the grounded conductive layer of the autoshading system. Integration of the antenna(s) in this manner allows operation of the antenna(s) without electromagnetic interference.

The glazing according to the present disclosure includes either glass or polymer glazing. In some examples, polymer glazing is used along with structural composites. The structural composites are used as a spacer to secure the autoshading layer in a predetermined position in the glazing.

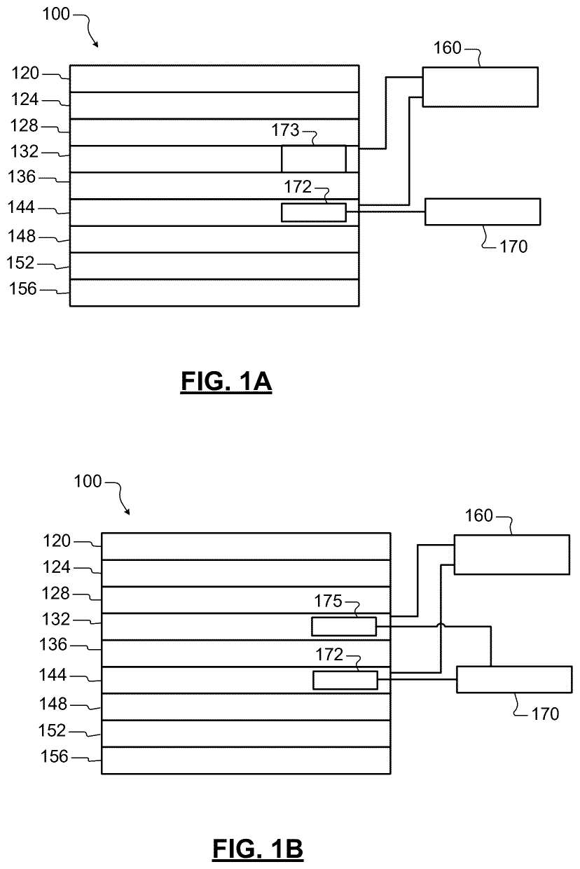

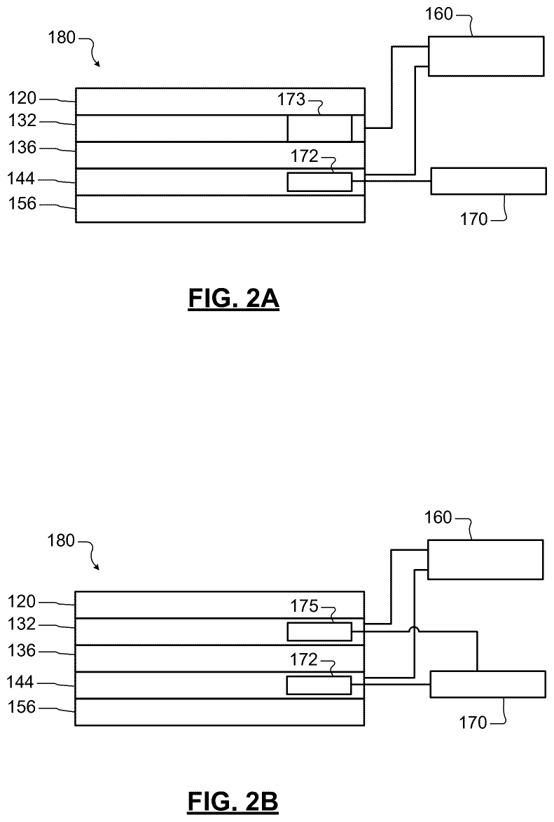

Referring now to FIGS. 1A to 2B, glazing 100 includes autoshading and one or more antennas. In FIGS. 1A and 1B, the glazing 100 includes a layer 120 including a glass layer and/or a polymer layer. A layer 124 acts as a transparent adhesive layer. In some examples, the layer 124 includes polyvinyl butyral (PVB) or ethylene vinyl acetate (EVA).

A layer 128 provides support, is transparent, and is arranged adjacent to the layer 124. In some examples, the layer 128 includes a transparent material such as polyethylene terephthalate (PET). A first conductive layer 132 is arranged between the layer 128 and an autoshading layer 136. In some examples, the autoshading layer 136 includes an electrochromic (EC) layer or a polymer dispersed liquid crystal (PDLC).

A second conductive layer 144 is arranged between the autoshading layer 136 and a layer 148 such as PET. In some examples, one or both of the first conductive layer 132 and the second conductive layer 144 are transparent and include indium tin oxide (ITO), although other materials that are transparent or nontransparent can be used. When nontransparent layers are used for one or more layers of the glazing, the autoshading system changes the appearance of the glazing (rather than adjusting to fully transparent).

In some examples, the first conductive layer 132 and/or second conductive layer 144 (as shown) includes one or more antennas 172. In some examples, the one or more antennas comprise slot antennas. If one of the first conductive layer 132 and the second conductive layer 144 includes an antenna, the other of the first conductive layer 132 and the second conductive layer 144 may include an opening, a non-conductive portion, or another antenna aligned therewith to prevent detuning of the antenna.

In some examples, if multiple antennas are used, the antennas can be tuned to the same frequency band or different frequency bands. A layer 148 provides support and is arranged adjacent to the second conductive layer 144. In some examples, the layer 148 includes PET. A layer 152 includes a transparent adhesive layer such as PVB or EVA. The glazing 100 further includes a layer 156 including glass or a polymer layer.

An autoshading controller 160 biases the first conductive layer 132 at different voltage levels to vary shading of the autoshading layer 136 to change transparency or appearance of the glazing. The autoshading controller 160 biases the second conductive layer 144 at ground. One or more transceivers 170 send transmit signals to and receive received signals from the antenna(s) 172 in the second conductive layer 144.

In some examples, an opening (or non-conductive portion) or another antenna is arranged above the antenna 172. In FIG. 1A, an opening 173 (or non-conductive portion) is arranged above the antenna 172. In FIG. 1B, another antenna 175 is arranged above the antenna 172.

In FIGS. 2A and 2B, another example of glazing 180 including autoshading and an antenna is shown. In this example, the layers 124, 128, 148, and 152 of FIG. 1 are omitted and the layers 120 and 156 include polymer.

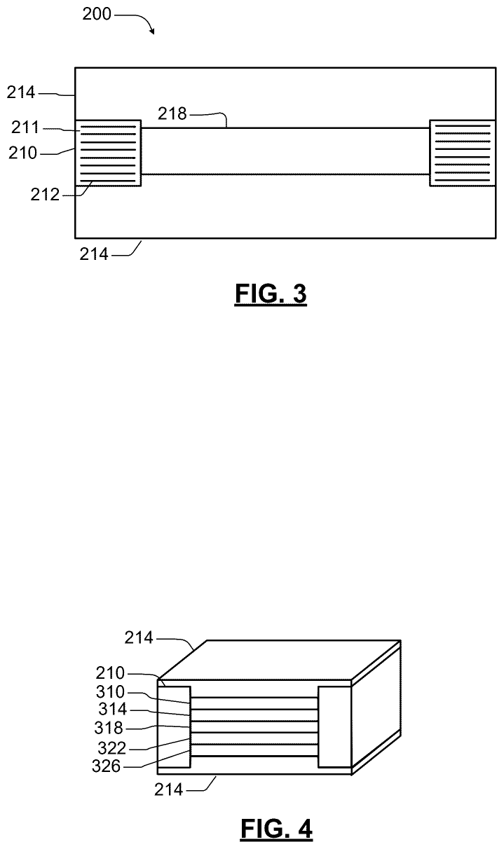

Referring now to FIGS. 3 to 5B, another example of glazing including autoshading and an antenna is shown. In FIGS. 3 and 4, glazing 200 includes first and second structural composites 210 including reinforcing fibers 212 embedded in polymer 211. In some examples, the first and second structural composites 210 are arranged on lateral sizes of the laminate 218.

In some examples, the reinforcing fibers 212 are conducting (e.g., carbon fibers). In some examples, the reinforcing fibers 212 are non-conducting (e.g., glass fibers). A laminate 218 including autoshading layers and one or more antennas is arranged between the first and second structural composites 210. The glazing 200 further includes a transparent polymer layer 214 encapsulating and/or surrounding one or more sides of the structural composite 210 and the laminate 218.

In some examples, the conductive layer(s) including the antenna(s) can extend beyond the autoshading layer to a more suitable location. In other words, the portion of the conductive layer including the antenna can be extended to a location adjacent to a structural composite (rather than adjacent to the autoshading layer) to obscure the antenna rather than allowing the antenna to be seen.

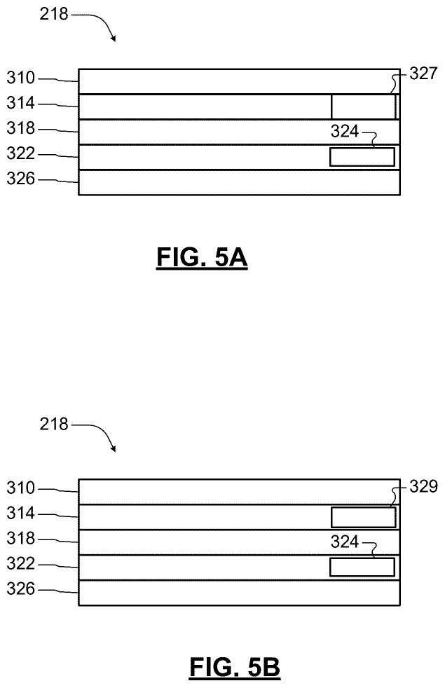

In FIGS. 5A and 5B, the laminate 218 is shown in further detail. A layer 310 provides support. In some examples, the layer 310 includes PET. A first conductive layer 314 is arranged between the layer 310 and an autoshading layer 318. A second conductive layer 322 is arranged between the autoshading layer 318 and a layer 326 such as PET. One or both of the first conductive layer 314 and the second conductive layer 322 includes one or more antennas 324. In FIG. 5A, an opening 327 is arranged above the antenna 172. In FIG. 2B, another antenna 329 is arranged above the antenna 172.

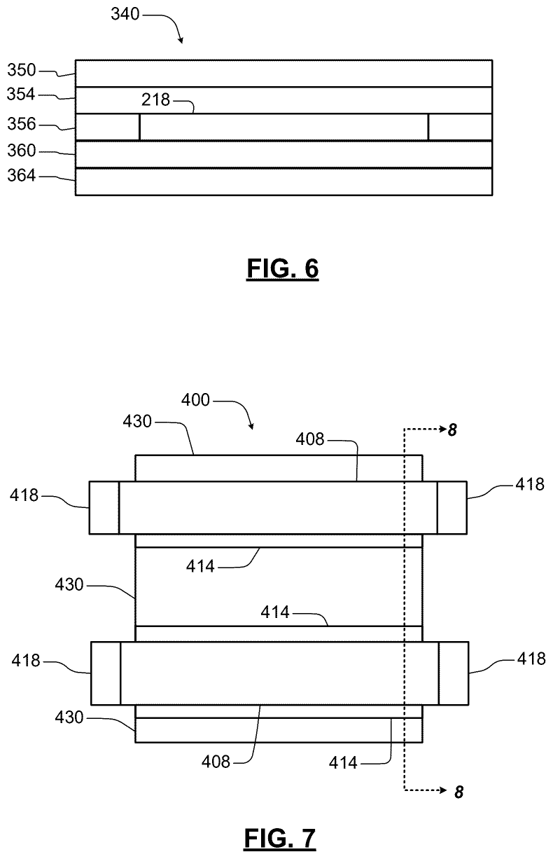

Referring now to FIG. 6, another example of glazing 340 including autoshading and one or more antennas is shown. In FIG. 5. the glazing 340 includes a layer 350 including glass or polymer. A layer 354 provides structural support. In some examples, the layer 354 includes PVB. The laminate 218 is arranged between the layer 354, a layer 360 providing structural support, and a PVB layer 356. In some examples, the layer 360 includes PVB. A layer 364 includes glass or polymer.

Referring now to FIGS. 7 to 10, other examples of glazing 400 including autoshading and an antenna is shown. In FIGS. 7 and 8, the glazing 400 is shown from first and second autoshading layers 408 downwards. The glazing 400 is shown to include the autoshading layers 408 arranged adjacent to and/or between structural composites 414. First and second conductive layers 418 are arranged below the first and second autoshading layers 408, respectively. A polymer layer 430 encapsulates the first and second autoshading layers 408, the first and second conductive layers 418, and/or the structural composites 414.

In FIG. 8, a cross section through the glazing 400 is shown. The first and second conductive layers 418 are arranged on opposite sides of the autoshading layer 408. The structural composites 414 are arranged on one or both sides of the autoshading layers 408 and the first and second conductive layers 418. The polymer layer 430 encapsulates the structural composite(s) 414, the autoshading layer 408, and the first and second conductive layers 418. Layers 440 such as PET may be arranged between the first and second conductive layers 418 and the polymer layer 430.

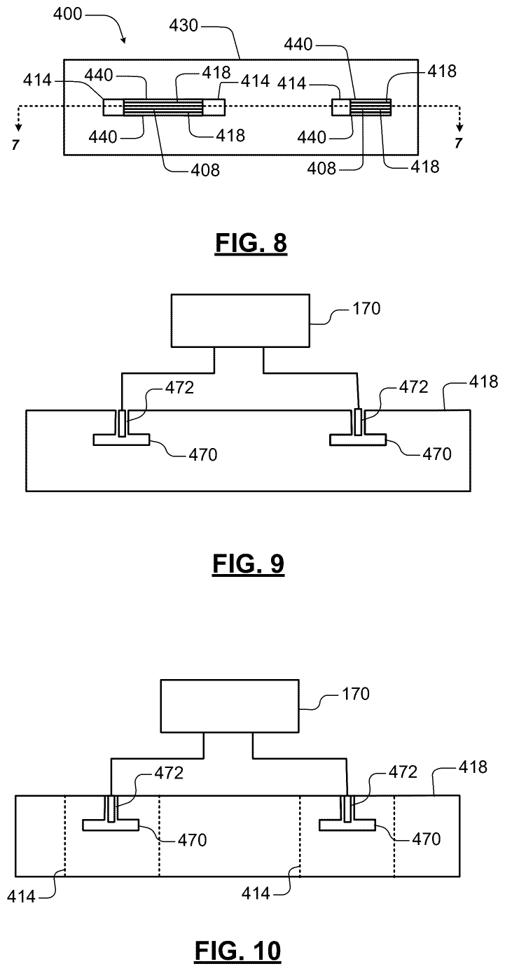

In FIG. 9, one of the first and second conductive layers 418 includes first and second slots 470 and first and second antenna feed conductors 472 (forming a slot antenna). The slot 470 creates an induced charge on the surface of the antenna feed conductor 472 that controls antenna performance. The antenna can be tuned by varying the slot size, material in the cavity (air, polymer, or another material), applied current, etc. The antennas radiate in a direction transverse to a plane of the one of the first and second conductive layers 418. In FIG. 10, the structural composite 414 is opaque and is arranged above a location of the conductive layer including the antennas 472 to prevent visual openings when looking at the glazing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A glazing system comprising:
a first transparent layer comprising at least one of glass and a polymer;
an autoshading layer;
a first conductive layer arranged on one side of the autoshading layer;
a second conductive layer arranged on an opposite side of the autoshading layer and including an antenna; and
a second transparent layer comprising at least one of glass and a polymer,
wherein the autoshading layer, the first conductive layer and the second conductive layer are arranged between the first transparent layer and the second transparent layer.

2. The glazing of claim 1, further comprising:
a first layer including polyethylene terephthalate (PET) and a second layer including at least one of polyvinyl butyral (PVB) and ethylene vinyl acetate (EVA) arranged between the first transparent layer and the first conductive layer; and
a third layer including polyethylene terephthalate (PET) and a fourth layer including at least one of polyvinyl butyral (PVB) and ethylene vinyl acetate (EVA) arranged between the second transparent layer and the second conductive layer.

3. The glazing of claim 1, wherein the first conductive layer and the second conductive layer are transparent.

4. The glazing of claim 1, wherein the first conductive layer and the second conductive layer include indium tin oxide (ITO).

5. The glazing of claim 1, further comprising first and second structural composites arranged on opposite lateral sides of the autoshading layer, the first conductive layer, and the second conductive layer.

6. The glazing of claim 5, wherein:
the first and second structural composites comprise a polymer and reinforcing fibers encapsulated in the polymer, and
the reinforcing fibers are non-conducting.

7. The glazing of claim 1, wherein the antenna comprises a slot antenna.

8. The glazing of claim 5, wherein the antenna is arranged below at least one of the first and second structural composites.

9. The glazing of claim 8, further comprising a first polyethylene terephthalate (PET) layer arranged between the first transparent layer and the first conducting layer and a second PET layer arranged between the second transparent layer and the second conducting layer.

10. A vehicle comprising:
the glazing of claim 1;
a transceiver configured to transmit signals to and receive signals from the antenna; and
an autoshading controller configured to adjust shading of the autoshading layer.

11. The vehicle of claim 10, wherein the glazing system comprises one of a roof, a windshield, and a rear window of the vehicle.

12. A glazing system comprising:
a first layer comprising polyethylene terephthalate (PET);
a first conductive layer arranged on one side of the first layer;
an autoshading layer arranged adjacent to the first conductive layer;
a second conductive layer arranged adjacent to the autoshading layer and including an antenna;
a second layer comprising PET arranged adjacent to the second conducting layer;
a first structural composite arranged laterally adjacent to one side of the first layer, the first conductive layer, the autoshading layer, the second conductive layer, and the second layer; and
a polymer layer encapsulating the structural composite, the first layer, the first conductive layer, the autoshading layer, the second conductive layer, and the second layer.

13. The glazing of claim 12, wherein at least one of the first conductive layer and the second conductive layer is transparent.

14. The glazing of claim 12, wherein the first conductive layer and the second conductive layer include indium tin oxide (ITO).

15. The glazing of claim 12, further comprising a second structural composite arranged laterally adjacent to an opposite side of the first layer, the first conductive layer, the autoshading layer, the second conductive layer, and the second layer, wherein the second structural composite is encapsulated in the polymer layer.

16. The glazing of claim 12, wherein:
the first structural composite comprises a polymer and reinforcing fibers encapsulated in the polymer, and
the reinforcing fibers are non-conducting.

17. The glazing of claim 16, wherein the antenna comprises a slot antenna.

18. A vehicle comprising:
the glazing of claim 12;
a transceiver configured to transmit signals to and receive signals from the antenna; and
an autoshading controller configured to adjust shading of the autoshading layer,
wherein the glazing system comprises one of a roof, a windshield, and a rear window of the vehicle.

19. A glazing system comprising:
a first transparent layer comprising at glass;
a first layer including polyethylene terephthalate (PET) arranged adjacent to the first transparent layer;
a second layer including at least one of polyvinyl butyral (PVB) and ethylene vinyl acetate (EVA) arranged adjacent to the first layer;
a first transparent conductive layer comprising indium tin oxide (ITO) arranged adjacent to the second layer;
an autoshading layer arranged adjacent to the first transparent conductive layer;
a second transparent conductive layer comprising ITO arranged on an opposite side of the autoshading layer and including an antenna;
a third layer including polyethylene terephthalate (PET) arranged adjacent to the second transparent conductive layer;
a fourth layer including at least one of polyvinyl butyral (PVB) and ethylene vinyl acetate (EVA) arranged adjacent to the third layer; and
a second transparent layer comprising glass arranged adjacent to the fourth layer.

20. A vehicle comprising:
the glazing of claim 19;
a transceiver configured to transmit signals to and receive signals from the antenna; and
an autoshading controller configured to adjust shading of the autoshading layer, wherein the glazing system comprises one of a roof, a windshield, and a rear window of the vehicle.
